(19) United States
(12) Patent Application Publication
(10) Pub. No.: US 2020/0248493 A1
(43) Pub. Date: Aug. 6, 2020

(54) OPENING AND CLOSING BODY CONTROL DEVICE

(71) Applicant: HI-LEX Corporation, Hyogo (JP)

(72) Inventors: Yoshiki KAMEMOTO, Hyogo (JP); Atsushi JOKO, Osaka (JP)

(73) Assignee: HI-LEX Corporation, Hyogo (JP)

(21) Appl. No.: 16/652,046

(22) PCT Filed: Oct. 29, 2018
(86) PCT No.: PCT/JP2018/040187

§ 371 Date: Mar. 29, 2020

(30) Foreign Application Priority Data
Oct. 27, 2017 (JP) 2017-208041

(51) Int. Cl. E05F 15/41; E05F 15/695

(52) U.S. Cl. CPC E05F 15/41; E05F 15/611; E05F 15/695

(57) ABSTRACT

An opening and closing body control device includes: an opening and closing body; a drive section which includes a motor; a detection section; a control section; and an amplifier which compares a counter electromotive force of the motor with a ground and amplifies the counter electromotive force to power that enables the control section to operate. In the opening and closing body control device, the control section is capable of shifting back and forth between an operation state and a low power consumption state, and when the counter electromotive force is generated by the motor in the low power consumption state, the control section shifts from the low power consumption state to the operation state by amplified power generated through amplification of the counter electromotive force by the amplifier and controls the opening and closing movement of the opening and closing body.

### TECHNICAL FIELD

The present invention relates to an opening and closing body control device.

### BACKGROUND ART

An opening and closing body drive device which drives an opening and closing body drives the opening and closing body by driving of a drive section which drives a motor. With respect to the driving by the drive section, the driving is controlled to be stopped in a fully-open position or a fully-closed position of the opening and closing body, and thus a control section controls the driving. When an external force such as a person's center of gravity and wind affects the opening and closing body during closing operation, the closing operation is accelerated to generate a sudden movement.

As an opening and closing body drive device that does not generate such a sudden movement, there is known a control device configured to perform a brake operation that causes an electric motor to rotate by a motor drive section for a predetermined time in a direction reverse to the rotating direction prior to stop of the electric motor in a case where a value of a current which flows through the electric motor immediately prior to the stop of the electric motor and which is detected by a current detection section after the stop of the electric motor is equal to or more than a threshold (for example, see Patent Literature (hereinafter, referred to as “PTL”) 1).

### CITATION LIST

### Patent Literature

### PTL 1

Japanese Patent Application Laid-Open No. 2013-087477

### SUMMARY OF INVENTION

### Technical Problem

However, the control device disclosed in PTL 1 cannot determine a motor current value with respect to the threshold in a case where an external force is applied to an opening and closing body in an open state when a control section is in a stop state or a sleep state, and the actual position of the opening and closing body deviates from a planned opening and closing position.

Further, in a case where the control section is in the stop state or the sleep state when the position of the opening and closing body changes by application of an external force to the opening and closing body, it is not easy for the control section to recognize a difference between the positions before and after the stop state or the sleep state, and restriction of the motor occurs in a fully-open position or a fully-closed position. In particular in a case where the opening and closing body moves by an external force such as wind or vibration, which is weaker than an impact and/or the like, it is difficult for the control section to recognize a difference between the positions before and after the stop state or the sleep state.

An object of the present invention is to provide an opening and closing body control device which enables a control section to, even when an external force is applied to an opening and closing body, resumes from a stop state or a sleep state and accurately recognize movement of a position of the opening and closing body.

### Solution to Problem

The opening and closing body control device of the present invention includes:

an opening and closing body;

a drive section which includes a motor and moves the opening and closing body to open or close;

a detection section which detects movement of a position of the opening and closing body;

a control section which controls opening and closing movement of the opening and closing body by using a signal from the detection section; and

an amplifier which compares a counter electromotive force of the motor with a ground and amplifies the counter electromotive force to power that enables the control section to operate, in which

the control section is capable of shifting back and forth between an operation state and a low power consumption state, and

when the counter electromotive force is generated by the motor in the low power consumption state, the control section shifts from the low power consumption state to the operation state by amplified power generated through amplification of the counter electromotive force by the amplifier and controls the opening and closing movement of the opening and closing body.

### Advantageous Effects of Invention

According to the present invention, even when an external force is applied to an opening and closing body, a control section can resume from a stop state or a sleep state and accurately recognize movement of a position of the opening and closing body.

### BRIEF DESCRIPTION OF DRAWINGS

FIG. 1 is a perspective view of a rear portion of an automobile illustrating an opening and closing body control device of an embodiment of the present invention,

FIG. 2 is a side view of the opening and closing body control device of FIG. 1,

FIG. 3 is a block diagram provided for describing a control system of the opening and closing body control device of FIG. 1, and

FIG. 4 is a flowchart provided for describing control of the opening and closing body for opening and closing in the opening and closing body control device of FIG. 1.

### DESCRIPTION OF EMBODIMENTS

Hereinafter, an embodiment of the present invention will be described in detail with reference to the drawings. Note that, an automobile which controls opening and closing of a back door is illustrated in the present embodiment, as an example of opening and closing body control device 1, but opening and closing body control device 1 is applicable to a device which controls opening and closing of a shutter, a sliding door or a hinged door installed at a structure such as a store and a garage, or foldable eaves disposed above an opening of a front of the structure.

[Overall Configuration of Opening and Closing Body Control Device]

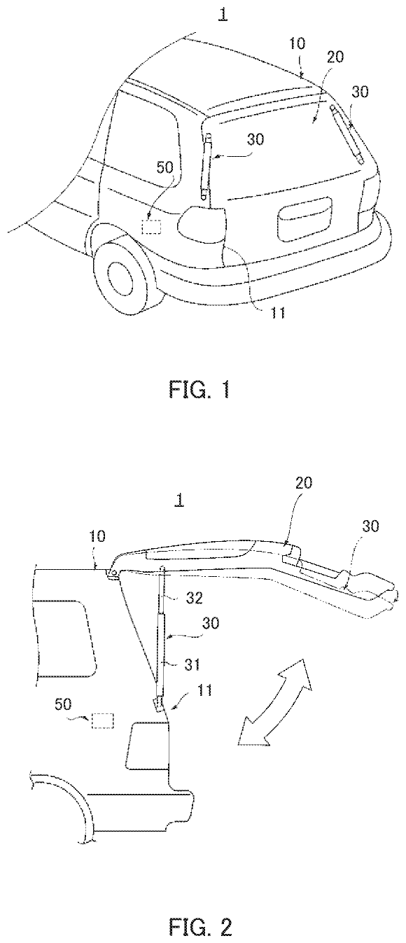

FIG. 1 is a perspective view of a rear portion of the automobile illustrating the opening and closing body control device of the present embodiment, and FIG. 2 is a side view of the opening and closing body control device of the present embodiment.

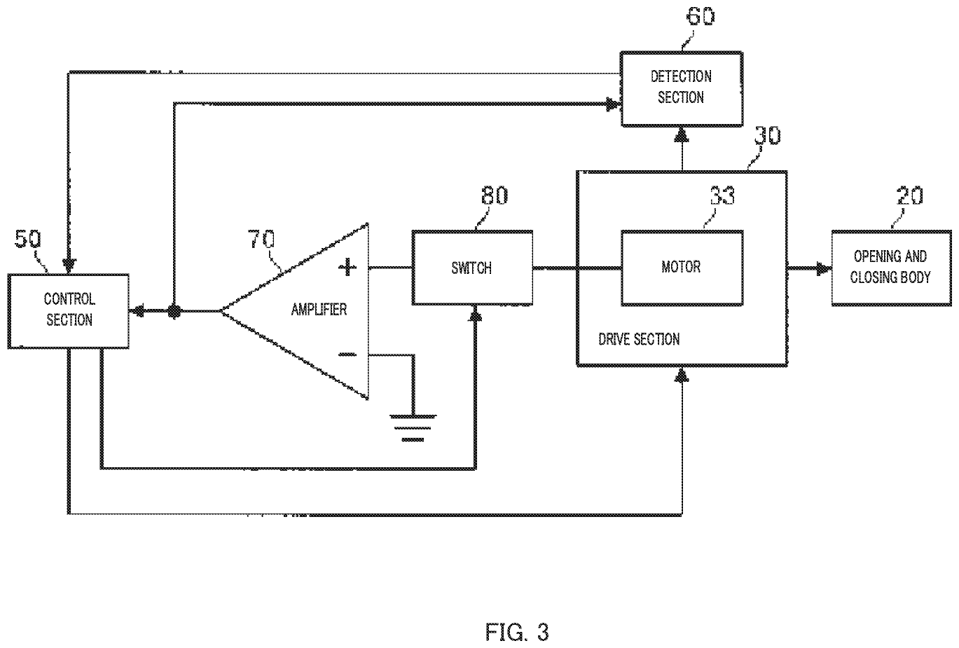

As illustrated in FIG. 1 and FIG. 2, opening and closing body control device 1 includes opening member 10 which includes opening 11, opening and closing body 20, drive sections 30, control section 50, detection section 60 (see FIG. 3), and amplifier 70 (see FIG. 3).

Opening and closing body control device 1 is a device which transitions between opening and closing body 20 an open state and a closed state with respect to opening 11 of opening member 10.

[Opening Member]

Opening member 10 is provided in a rear portion of a vehicle body in the automobile shown as an example of opening and closing body control device 1 in the present embodiment. The shape of opening 11 may be any shape including a rectangular shape, a circular shape and/or the like.

[Opening and Closing Body]

Opening and closing body 20 sets opening 11 of opening member 10 to an open state (see FIG. 2) or a closed state (see FIG. 1). In the rear portion of the automobile, the open state of opening 11 is a state where movement of an object, such as luggage, between the outside and the inside via opening 11 is allowed. The closed state of opening 11 is a state where it is difficult to move an object via opening 11. For example, when opening and closing body 20 is in a position to block this object, such as luggage, from passing through opening 11 and moving to an opposite side, opening and closing body 20 can set opening 11 to the closed state. Further, when opening and closing body 20 is in a position to allow the object to pass through opening 11 and move to the opposite side, opening and closing body 20 can set opening 11 to the open state.

In the present embodiment, an upper side portion of opening and closing body 20 is turnably attached to a side of an upper edge portion of opening 11 in opening member 10 via a shaft portion. Opening and closing body 20 sets opening 11 to the open state or the closed state by turning such that a side of a lower portion of opening and closing body 20 vertically moves around the shaft portion. In the present embodiment, the positional change of opening and closing body 20 is achieved by the turning mechanism described above, but the mechanism for positional change of opening and closing body 20 is not limited to turning and may be any mechanism as long as opening 11 can be set to the open state or the closed state.

[Drive Section]

Drive section 30 moves opening and closing body 20 in an opening direction or a closing direction with respect to opening 11 of opening member 10. More than one drive section 30 may be provided. In the present embodiment, drive section 30 is provided one each in total of two to both left and right edges of opening and closing body 20 and both left and right edges of opening 11. Opening and closing body 20 is relatively moved with respect to opening member 10 by moving opening and closing body 20 by driving respective drive sections 30, and thus, opening 11 is set to the open state or the closed state.

As long as two drive sections 30 are capable of moving opening and closing body 20 in a direction in which opening 11 is set to the open state (opening direction) and in a direction in which opening 11 is set to the closed state (closing direction), respective drive sections 30 may drive opening and closing body 20 in the same direction with the same driving amount. Further, when two respective drive sections 30 are capable of moving opening and closing body 20 in the opening direction and in the closing direction, two drive sections 30 may drive opening and closing body 20 in different directions with different driving amounts. In the present embodiment, each drive section 30 is provided so as to perform the same driving in synchronization with each other.

Drive sections 30 are provided between opening member 10 and opening and closing body 20 such that opening and closing body 20 is relatively movably provided with respect to opening member 10. In order for opening and closing body 20 to turnably move with respect to opening member 10, each drive section 30 is rotatably attached to opening member 10 so as to be capable of driving while turning by following the turn of opening and closing body 20.

More specifically, each drive section 30 has a telescopic bar shape appearance and includes a driving main-body portion, which is disposed on a side of one end portion of drive section 30 and is connected to a side of opening member 10, and a forward-backward moving section, which is disposed on a side of the other end portion of drive section 30 and is connected to a side of opening and closing body 20. The forward-backward moving section is attached so as to be capable of protruding and receding from a side of the other end portion of the driving main-body portion.

Drive section 30 can move, by moving the forward-backward moving section forward and backward in a longitudinal direction of drive section 30 with respect to the driving main-body portion, opening and closing body 20 to a fully-closed position, i.e., the position where opening and closing body 20 completely covers opening 11, and to a fully-open position, i.e., the position where opening 11 becomes a state where opening 11 is opened to a maximum extent. Each drive section 30 moves opening and closing body 20 in the opening direction or the closing direction by converting a rotary motion of a motor or the like into an extension and retraction motion in a linear direction.

Drive sections 30 are provided one each to both left and right ends of the rear portion of the automobile in total of two, but the number of drive sections 30 to be used is not particularly limited. Further, as long as drive section 30 enables opening and closing of opening and closing body 20, the structure, shape and/or installation position of drive section 30 is not particularly limited. As drive section 30, a publically known drive section capable of driving opening and closing body 20, can be employed.

In the present embodiment, drive section 30 includes main-body cylinder portion 31, sliding cylinder portion 32, motor 33 (see FIG. 3), a spindle (illustration is omitted), a spindle nut (illustration is omitted), an energizing member (illustration is omitted) and/or the like as illustrated in FIG. 1 and FIG. 2. In drive section 30, main-body cylinder portion 31, motor 33, the spindle, the energizing member and/or the like correspond to the driving main-body portion, and sliding cylinder portion 32 and the spindle nut correspond to the forward-backward moving section.

Main-body cylinder portion 31 is rotatably fixed to opening member 10 on a side of one end portion of main-body cylinder portion 31 and is opened on a side of the other end thereof. Sliding cylinder portion 32 is disposed inside of main-body cylinder portion 31 such that sliding cylinder portion 32 is slidingly movable in the longitudinal direction so as to protrude and recede from the side of the other end portion of main-body cylinder portion 31.

Motor 33 drives to move the forward-backward moving section in the longitudinal direction with respect to the driving main-body section to extend and retract drive section 30. Motor 33 is a DC motor or an AC motor. In a case where opening and closing body control device 1 is applied to an automobile, a DC motor is preferably adopted as motor 33 in considering that a DC power supply of the automobile is used. Note that, motor 33 is connected to control section 50, and rotational driving of both forward rotation and reverse rotation is controlled by control section 50.

Sliding cylinder portion 32 is energized by the energizing member from one end side to the other end side of main-body cylinder portion 31. Inside of sliding cylinder portion 32, the spindle nut is provided, and the spindle screwed with the spindle nut axially rotates by rotation of motor 33.

Drive section 30 is configured such that both of main-body cylinder portion 31 and sliding cylinder portion 32 do not corotate due to the rotation of the spindle. When motor 33 rotates in a forward or reverse direction, the spindle rotates in axially forward or reverse direction, and the spindle nut screwed with the spindle moves along the longitudinal direction of the spindle. Along with this movement, sliding cylinder portion 32 including the spindle nut moves forward and backward, that is, slidingly moves in the longitudinal direction. Thus, drive section 30 moves so as to extend and retract, and opening and closing body 20 is operated to be opened and closed in correspondence to a length of advance of sliding cylinder portion 32 from main-body cylinder portion 31.

[Configuration of Control System]

FIG. 3 is a block diagram illustrating a control system of opening and closing body control device 1.

In opening and closing body control device 1, the control system includes control section 50, detection section 60, amplifier 70, and switch 80. The control system of opening and closing body control device 1 controls opening and closing body 20 to be driven by drive section 30 including motor 33.

[Detection Section]

Detection section 60 detects movement of the position of opening and closing body 20 by detecting an operation of drive section 30, and outputs a result of the detection to control section 50. The operation of drive section 30 may be a signal indicating an operation of drive section 30 itself or may be a signal corresponding to an operation of drive section 30.

Detection section 60 is not particularly limited as long as detection section 60 can detect the position of opening and closing body 20. As detection section 60, it is possible to adopt a sensor that can detect the position as an electrical signal such as a pulse signal. Detection section 60 which detects the position of opening and closing body 20 by an electrical signal can detect the position of opening and closing body 20 by positioning detection section 60 in a path where a driving force from drive section 30 to opening and closing body 20 is transmitted. Detection section 60, for example, includes Hall elements, and detects the operation of drive section 30, that is, movement of the position of opening and closing body 20 by magnetically detecting a rotation state of motor 33. In this case, magnets are positioned circumferentially with different intervals on a disk provided on the rotation shaft of motor 33, and the Hall elements of detection section 60 are disposed in positions facing the magnets. Using the Hall elements, magnets moving along with the rotation of the rotation shaft of motor 33 are captured with pulses, and the position of opening and closing body 20 is presumed by a count value of the captured pulses. Detection section 60 counts the captured pulses, and outputs the count value as a result of the detection to control section 50, and thus the count value of the pulses can be used for presuming the position of opening and closing body 20 in control section 50. Note that, it is also possible to adopt a configuration in which detection section 60 not only counts pulses, but also presumes the position of opening and closing body 20 based on the count value, and outputs the result of the presumption of the position of opening and closing body 20 to control section 50.

Note that, a count value of pulses may be used for computing a driving speed of drive section 30, and the position of opening and closing body 20 may be presumed based on the result of the computation.

Further, an operation of drive section 30 may be detected by any configuration or principle, and may be detected by monitoring a voltage or a current supplied to motor 33 or a voltage or a current of an electromotive force of motor 33.

Further, it is also possible to adopt a configuration in which an operation of drive section 30 is detected by using a camera and/or the like as detection section 60. Further, the number of detection sections 60 is not particularly limited either. One detection section 60 may detect a state of operation of drive sections 30 and may output driving information on respective drive sections 30. Alternatively, a state of operation of respective drive sections 30 may be detected by detection sections 60 corresponding to respective drive sections 30.

Further, as long as detection section 60 is capable of detecting information on movement of the position of opening and closing body 20, detection section 60 may adopt any configuration, and for example, detection section 60 may be configured to detect movement of the position of opening and closing body 20 directly without detecting an operation of drive section 30. Further, although detection section 60 has been described as a detection section that is provided separately from control section 50 to be described later, detection section 60 may be a detection section incorporated into control section 50.

[Control Section]

For control section 50, it is possible to adopt a publically known configuration. Control section 50 includes a central processing unit (CPU), a read only memory (ROM), and a random access memory (RAM) and/or the like. The CPU reads a program from the ROM in accordance with a processing content, loads the program into the RAM, and performs centralized control for operation of each block of opening and closing body control device 1 in cooperation with the loaded program. At this time, various types of data stored in a storage section (illustration is omitted) are referred to. The storage section (illustration is omitted) is, for example, formed of a nonvolatile semiconductor memory (so-called flash memory) and/or a hard disk drive. Control section 50, for example, may be incorporated into an electronic control unit (ECU) which controls each part of a vehicle, or may be mounted on drive section 30.

Control section 50 controls opening and closing movement of opening and closing body 20 via drive section 30, using a signal (result of detection) from detection section 60. More specifically, control section 50 determines the position of opening and closing body 20 based on the result of the detection by detection section 60. The position of opening and closing body 20 is stored in the storage section (illustration is omitted) as needed. Further, in a case where an operation command and/or the like of opening and closing body 20 is present, control section 50 controls the driving speed of opening and closing body 20 in accordance with the current position information on opening and closing body 20.

Further, control section 50 is configured to be capable of shifting back and forth between an operation state and a low power consumption state.

The operation state herein refers to a state in which control section 50 can execute control of opening and closing by each drive section 30 which moves opening and closing body 20 in an opening direction or a closing direction. The low power consumption state refers to a state in which the control of opening and closing by each drive section 30 is restricted due to restriction on power to be supplied to control section 50. Examples of the low power consumption state include a sleep state and a stop state. In the sleep state, power supply to all or part of control section 50 is stopped, or control section 50 operates in a state in which the clock frequency is lowered than a predetermined frequency. In the stop state, control section 50 stops completely.

Control section 50 shifts between the operation state and the low power consumption state by acquiring a command signal from, for example, the ECU, a control device capable of controlling the state of control section 50, and/or the like. Note that, control section 50 may shift between the operation state and the low power consumption state by a command from the CPU and/or the like provided in control section 50 itself.

Conditions that cause control section 50 to be shifted from the operation state to the low power consumption state include, for example, a condition that an ignition switch of an automobile is turned OFF, a condition that opening and closing body 20 stops in the open state and a predetermined time (five minutes or the like, for example) has elapsed in the stop state, and the like. Further, the conditions that cause control section 50 to be shifted from the operation state to the low power consumption state may also include a condition that opening and closing body 20 stops in the closed state and a predetermined time has elapsed in the stop state. The conditions that cause control section 50 to be shifted from the operation state to the low power consumption state may also be a case of restricting the driving, such as a case where work is performed in a state where opening and closing body 20 is maintained in the open state.

The conditions that cause control section 50 to be shifted from the low power consumption state to the operation state include a condition that control section 50 when being in a predetermined power supply state has received an input of amplified power which is output from amplifier 70 to be described later. Further, the conditions that cause control section 50 to be shifted from the low power consumption state to the operation state may include, for example, a condition that an operation signal with respect to control section 50 has been output from an on-vehicle switch or a remote controller that a user can operate, and the like.

[Amplifier]

Amplifier 70 amplifies the counter electromotive force generated from motor 33, and outputs amplified power obtained by the amplification to control section 50. Amplifier 70 includes, for example, an amplification circuit such as an operational amplifier and a comparator. In the present embodiment, amplifier 70 includes a comparator. A case where amplifier 70 is configured to include a comparator is advantageous compared to a case where amplifier 70 is configured to include an op-amp in terms of the former case making an input of a reference voltage unnecessary and making the circuit configuration simpler. Amplifier 70 may be configured to include any other circuit such as a publically known fall detection circuit which can detect a fall of opening and closing body 20, for example.

A positive input terminal of amplifier 70 is electrically connected to motor 33, and a negative input terminal of amplifier 70 is connected to the ground. Note that, switch 80 capable of electrically connecting and disconnecting between amplifier 70 and motor 33 is interposed between amplifier 70 and motor 33 in the present embodiment. Switch 80 will be described later. On a positive side of amplifier 70, the counter electromotive force of motor 33 is input whenever switch 80 is in the ON state. Further, an input voltage to a negative side of amplifier 70 is held at the ground level all the time. An output terminal of amplifier 70 is connected to control section 50, and amplifier 70 outputs amplified power to control section 50. Note that, the connection in an amplification circuit of amplifier 70 may be any connection, but it is preferable to simplify the circuit configuration and minimize a processing delay by configuring the control system such that amplified power is directly input from amplifier 70 to control section 50.

When there is a difference between a positive input voltage (counter electromotive force) and a negative input voltage (ground), that is, when the counter electromotive force is generated, amplifier 70 amplifies the counter electromotive force to amplified power. Amplified power is power required to operate control section 50 in the stop state or the sleep state, or such power that control section 50 can recognize as a signal to shift control section 50 in the low power consumption state to the operation state. Control section 50 shifts from the low power consumption state to the operation state by inputting the amplified power. That is, when amplifier 70 detects an electromotive force in comparison with the ground such as the comparator and amplifies the electromotive force to power to enable control section 50 to be driven, even a very small electromotive force can be amplified as power derived from movement of opening and closing body 20.

Hereinafter, the counter electromotive force of motor 33 will be described. When the power supply is off, motor 33 is in a free state. In this state, opening and closing body 20 supported by drive section 30 can be moved by an external force, for example manually. That is, when an attempt is made to move sliding cylinder portion 32 in the longitudinal direction via opening and closing body 20 by applying a load to opening and closing body 20, the spindle nut screwed with the spindle follows and extends and retracts in the longitudinal direction in a free state, and opening and closing body 20 can move in the opening direction or the closing direction.

For example, when opening and closing body 20 moves in the closing direction by application of an external force to opening and closing body 20 in the open state, drive section 30 is retracted in the longitudinal direction. A linear motion due to the retraction of drive section 30 is converted by rotation of the spindle to a rotational motion of a rotational shaft of motor 33 in a free state. As a result, the counter electromotive force due to movement of opening and closing body 20 is generated in motor 33.

In the present embodiment, when the counter electromotive force is generated in motor 33, amplified power based on the counter electromotive force is output from amplifier 70 to control section 50, and control section 50 shifts from the low power consumption state to the operation state. Thus, the position of opening and closing body 20 can be accurately recognized by acquiring a signal from detection section 60 by control section 50 that has shifted to the operation state.

Hereinafter, a comparative example is given which has a configuration that does not use the counter electromotive force of motor 33 for the shift of the state of control section 50. In this case, when an external force is applied to opening and closing body 20, the position of opening and closing body 20 stored in the storage section deviates from the actual position of opening and closing body 20. As a result, moving opening and closing body 20 to the fully-closed position or the fully-open position leads to a problem that motor 33 is restricted in the fully-closed position or the fully-open position since an actual amount of movement of opening and closing body 20 is smaller than an amount of movement of opening and closing body 20 to be moved by performing control of opening and closing body 20 for opening and closing. In the present embodiment, however, the occurrence of such a problem can be suppressed because control section 50 is rapidly shifted to the operation state by the counter electromotive force of motor 33 and the actual position of opening and closing body 20, which moves, is immediately recognized.

Further, when the external force to be applied to opening and closing body 20 is very small, an amount of movement of opening and closing body 20 also becomes very small. Examples in which the amount of movement of opening and closing body 20 becomes very small include, as illustrated in FIG. 2, a case in which opening and closing body 20 when being in the open state moves from the position of the solid line to the position of the two-dot chain line, and also include, as a matter of course, a case in which the amount of movement of opening and closing body 20 is further smaller than that when opening and closing body 20 moves to the position of the two-dot chain line. In such a case, the counter electromotive force to be generated in motor 33 also becomes very small.

It is assumed herein that a configuration is adopted in which the counter electromotive force is directly input from motor 33 to control section 50 and control section 50 is shifted to the operation state. In this configuration, when the counter electromotive force is input to control section 50 while the counter electromotive force is very small, there is a possibility that control section 50 cannot be shifted from the low power consumption state to the operation state. In this case, the position of opening and closing body 20 stored in the storage section still deviates from the position of opening and closing body 20.

A case where the counter electromotive force of motor 33 is very small means very small power that does not reach power required to operate control section 50 in the stop state or the sleep state, or such very small power that control section 50 cannot recognize as a signal for the shift from the low power consumption state to the operation state even if the counter electromotive force is input to control section 50.

In the present embodiment, the counter electromotive force is compared with the ground by amplifier 70, and thus, as long as there is a slight difference between both, even an extremely small counter electromotive force is amplified and is input as amplified power to control section 50. Thus, a very small movement of opening and closing body 20 can be accurately recognized by control section 50.

Although the present embodiment illustrates a configuration in which amplifier 70 and control section 50 are separate sections, it is also possible to adopt a configuration in which amplifier 70 is incorporated into control section 50.

Amplifier 70 may be configured to output amplified power not only to control section 50 but also to detection section 60. In a case where detection section 60 and control section 50 are separate sections and detection section 60 becomes a sleep state or a stop state as with control section 50, detection section 60 can be operated without delay when control section 50 shifts to the operation state by outputting amplified power to detection section 60 as well.

By using amplified power in amplifier 70 for operating detection section 60, detection section 60 can be operated simultaneously with the timing when control section 50 becomes the operation state. As a result, a start-timing of detection of rotation of motor 33 by detection section 60 and a start-timing of control of opening and closing by control section 50 can be the same timing, and the control of opening and closing body 20 for opening and closing can also be executed more precisely.

FIG. 3 illustrates a configuration in which detection section 60 is operated simultaneously with control section 50 by means of amplified power of amplifier 70. However, in a case where an electromotive power can operate control section 50 even when control section 50 is in the low power consumption state, an input of amplified power from amplifier 70 to detection section 60 may be omitted.

[Switch]

As described above, switch 80 is provided between amplifier 70 and drive section 30 in the present embodiment. More specifically, switch 80 is, for example, a transistor element or the like, and switches between an ON state in which an electromotive force (counter electromotive force) of motor 33 is input to amplifier 70 and an OFF state in which an electromotive force of motor 33 is not input to amplifier 70. Switch 80 is set to the ON state when control section 50 is in the low power consumption state, and is set to the OFF state when control section 50 is in the operation state.

It is not necessary to input an output of amplifier 70 to control section 50 after control section 50 has shifted from the low power consumption state to the operation state. Accordingly, control section 50 switches switch 80 to the OFF state immediately before control section 50 shifts from the low power consumption state to the operation state. As a result, power consumption in amplifier 70 during the operating state can be reduced. After control section 50 has shifted from the operation state to the low power consumption state, control section 50 needs to wait for an input of amplified power, and thus control section 50 switches switch 80 to the ON state immediately before control section 50 shifts from the operation state to the low power consumption state. These controls make it possible to ensure that the unnecessary input of amplified power to control section 50 is prevented, and that the necessary input of amplified power to control section 50 is executed.

Although the present embodiment illustrates a configuration in which switch 80 is provided between amplifier 70 and drive section 30, the configuration of the control system may be altered in various ways, provided that it is possible to ensure that the unnecessary input of amplified power to control section 50 is prevented, and that the necessary input of amplified power to control section 50 is executed. For example, switch 80 may be provided between amplifier 70 and control section 50.

Further, switch 80 is configured to be capable of electrically connecting and disconnecting between amplifier 70 and motor 33 in the present embodiment, but a configuration may be adopted in which the output destination of the counter electromotive force of motor 33 is switchable to amplifier 70 or control section 50. In this case, when control section 50 is in the low power consumption state, the counter electromotive force of motor 33 is input to amplifier 70 via switch 80, and amplified power by amplifier 70 is input to control section 50. Further, when control section 50 is in the operation state, the counter electromotive force of motor 33 is directly input to control section 50 via switch 80. The above configuration enables control section 50 in the operation mode to utilize unamplified counter electromotive force of motor 33 for the control of opening and closing body 20 for opening and closing.

Further, the counter electromotive force of motor 33 may also be input to control section 50 via a publically known circuit, such as a voltage detection circuit.

[Control of Opening and Closing Body for Opening and Closing in Opening and Closing Body Control Device]

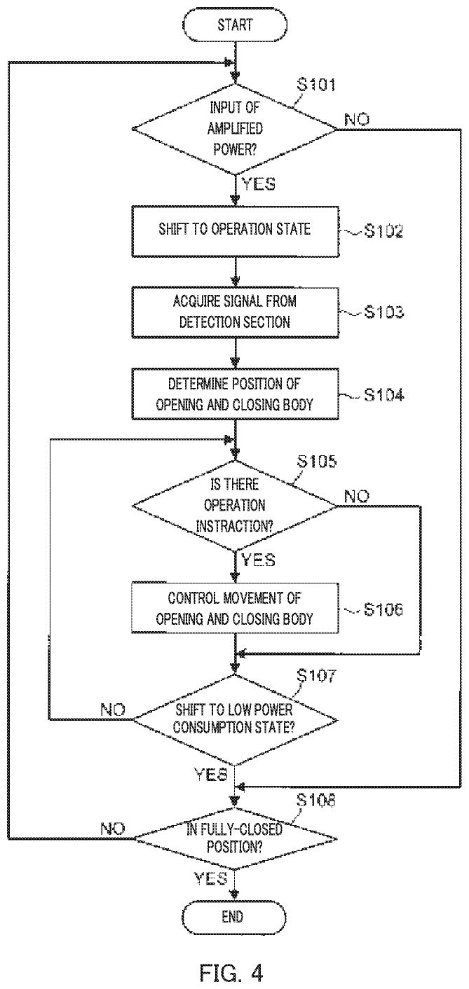

FIG. 4 is a flowchart provided for describing control of opening and closing body 20 for opening and closing in opening and closing body control device 1. Note that, the control in FIG. 4 is assumed to start when control section 50 is in the low power consumption state.

As indicated in FIG. 4, control section 50 determines whether amplified power has been input (step S101). In a case where amplified power has not been input as a result of the determination (step S101, NO), the processing transitions to step S108. In a case where amplified power has been input (step S101, YES), on the other hand, control section 50 is shifted from the low power consumption state to the operation state (step S102).

Next, control section 50 acquires a signal from detection section 60 (step S103). Control section 50 then determines the position of opening and closing body 20 based on the acquired signal from detection section 60 (step S104). Subsequently, control section 50 determines whether there is an operation command of opening and closing body 20 (step S105).

In a case where there is no operation command of opening and closing body 20 as a result of the determination (step S105, NO), the processing transitions to step S107. In a case where there is an operation command of opening and closing body 20 (step S105, YES), on the other hand, control section 50 performs control for moving opening and closing body 20 (step S106).

Thereafter, control section 50 determines whether to shift from the operation state to the low power consumption state (step S107). In a case where control section 50 does not shift to the low power consumption state as a result of the determination (step S107, NO), the processing returns to step S105. Note that, in a case where the position of opening and closing body 20 has moved by application of an external force to opening and closing body 20 during the processing from step S105 to step S107, the position of opening and closing body 20 in the storage section is updated each time based on a signal from detection section 60.

In a case where control section 50 shifts to the low power consumption state (step S107, YES), on the other hand, control section 50 determines whether opening and closing body 20 is in the fully-closed position (step S108). In a case where opening and closing body 20 is not in the fully-closed position as a result of the determination (step S108, NO), the processing returns to step S101.

In a case where opening and closing body 20 is in the fully-closed position (step S108, YES), on the other hand, the above control is terminated. Note that, even when opening and closing body 20 is in the fully-closed position, the processing may transition to step S101 in a case where it is assumed that the position of opening and closing body 20 changes by application of an external force to opening and closing body 20, and in a case where it is determined to be YES in step S107. Further the foregoing control may be replaced by the following control: control section 50 compares the counter electromotive force of drive section 30 with the ground, and amplifies the counter electromotive force. The amplification of the counter electromotive force may be performed in a case where the counter electromotive force is equal to or more than a predetermined threshold, and may not be performed in other cases. Control section 50, which has become the operation state by the amplified counter electromotive force with respect to the predetermined threshold, changes current position information indicating the current position of opening and closing body 20 based on a signal from detection section 60. As for the change of the current position information, for example, control section 50 may call current position information stored in the storage section and may update the current position information of opening and closing body 20 based on detection information from detection section 60. It is also possible to obtain the current position information, for example, by using an integrated value of pulses resulting from driving of drive section 30 and by adding and/or subtracting a count number from detection section 60 resulting from movement of opening and closing body 20 to and/or from the integrated value of pulses. Further, with respect to the detection information, the detection information may be obtained by operating detection section 60 by power resulting from amplifying the counter electromotive force or in a case where detection section 60 can be operated directly by means of the counter electromotive force, detection section 60 may be brought into the operation state without amplifying power.

[Effects]

According to the present embodiment described above, when the counter electromotive force is generated in motor 33, control section 50 shifts from the low power consumption state to the operation state by amplifier 70. Thus, control section 50 which has shifted to the operation state acquires a signal from detection section 60, and thus, the position of opening and closing body 20 can be accurately recognized. As a result, the occurrence of a deviation between the position of opening and closing body 20 stored in the storage section and the actual position of opening and closing body 20 can be suppressed, and the occurrence of restriction of motor 33 in the fully-open position or the fully-closed position can also be suppressed.

Further, since the counter electromotive force is compared with the ground by amplifier 70, even a very small counter electromotive force can be recognized. Thus, a very small movement of opening and closing body 20 can be accurately recognized by control section 50.

Further, since amplified power in amplifier 70 is used for operating detection section 60, detection section 60 can be operated simultaneously with the timing when control section 50 becomes the operation state. As a result, the start-timing of detection of rotation of motor 33 by detection section 60 and the start-timing of control of opening and closing by control section 50 can be the same timing, and the position of opening and closing body 20 can also be detected more precisely.

The embodiment disclosed this time is only exemplary in every aspect and should be considered nonrestrictive. The scope of the present invention is indicated not by the description above but by claims, and it is intended that every change within meaning or range equivalent to the claims is included.

The embodiment of the present invention has been described thus far. Note that, the above description is only illustration of a preferred embodiment of the present invention, and the scope of the present invention is not limited to this. That is, the descriptions of the configuration of the above-mentioned device and the shape of each portion are only exemplary, and it is obvious that various changes and additions to these examples are possible within the scope of the present invention.

### INDUSTRIAL APPLICABILITY

The opening and closing body control device according to the present invention is useful as an opening and closing body control device in which, even when an external force is applied to an opening and closing body, a control section can resume from a stop state or a sleep state and can accurately recognize movement of a position of the opening and closing body.

### REFERENCE SIGNS LIST

1 Opening and closing body control device
10 Opening member
11 Opening
20 Opening and closing body
30 Drive section
31 Main-body cylinder portion
32 Sliding cylinder portion
33 Motor
50 Control section
60 Detection section
70 Amplifier
80 Switch

1. An opening and closing body control device, comprising:
an opening and closing body;
a drive section which includes a motor and moves the opening and closing body to open or close;
a detection section which detects movement of a position of the opening and closing body;
a control section which controls opening and closing movement of the opening and closing body, using a signal from the detection section; and
an amplifier which compares a counter electromotive force of the motor with a ground and amplifies the counter electromotive force to power that enables the control section to operate, wherein
the control section is capable of shifting back and forth between an operation state and a low power consumption state, and
when the counter electromotive force is generated by the motor in the low power consumption state, the control section shifts from the low power consumption state to the operation state by amplified power generated through amplification of the counter electromotive force by the amplifier and controls the opening and closing movement of the opening and closing body.

2. The opening and closing body control device according to claim 1, wherein
the amplifier causes the detection section to operate by the amplified power, and
the control section controls the opening and closing movement of the opening and closing body, using a signal from the detection section operated by the amplified power.

3. The opening and closing body drive device according to claim 1, wherein
the detection section counts pulses generated by rotation of a driving shaft of the drive section, and
the control section determines the position of the opening and closing body by a count value of the pulses.
